(19) United States
(12) Patent Application Publication
(10) Pub. No.: US 2023/0419374 A1
(43) Pub. Date: Dec. 28, 2023

(54) INFORMATION PROCESSING SYSTEM

(71) Applicant: mov inc., Tokyo (JP)

(72) Inventor: Makoto WATANABE, Tokyo (JP)

(73) Assignee: mov inc., Tokyo (JP)

(21) Appl. No.: 18/039,544

(22) PCT Filed: Dec. 11, 2020
(86) PCT No.: PCT/JP2020/046364

§ 371 Date: May 31, 2023

(51) Int. Cl. G06Q 30/0282

(52) U.S. Cl. CPC G06Q 30/0282

(57) ABSTRACT

An information processing system 10 of the present invention includes an acquisition means 11 for acquiring posted information corresponding to a specific object from each of a plurality of posting websites on which the posted information, posted by a user who used the specific object, is disclosed on the Internet; and an output means 12 for outputting the posted information corresponding to the specific object acquired from each of the plurality of posting websites so as to display the posted information in a list.

### TECHNICAL FIELD

The present invention relates to an information processing system, an information processing method, and a program.

### BACKGROUND ART

In recent years, a plurality of posting websites are opened on the Internet. Posting websites are websites on which posted information regarding evaluation of stores and products and used situations by the users are disclosed. In such posting websites, for example, when posted information such as photographs of the interior and the food of a store such as a restaurant, text describing the atmosphere of the store and impressions of the use, and the like are posted by a user, the posted information is disclosed to be viewable by general users collectively for each store or each product. As a result, general users can choose a store or a product with reference to the posted information.

Meanwhile, posted information by the users of a store or a product may contain inappropriate contents for the store or the product. This causes a problem of reliability of the posted information. In order to solve such a problem, there is a case where a store or a provider of a product manually monitors the posted information, or evaluates the users who posted information. For example, Patent Literature 1 describes art to evaluate contributors according to the number of his/her past posts or the number of adopted posts, and acquire posted information given by those having high evaluation.

### CITATION LIST

### Patent Literature

Patent Literature 1: JP 2020-35021 A

### SUMMARY OF INVENTION

### Technical Problem

However, in the method of Patent Literature 1, users who desire to refer to posted information can refer to only posted information given by some contributors, and cannot refer to posted information given by all contributors. Therefore, although it is desirable to disclose posted information given by all contributors, it is necessary to manually monitor the posted information by a store or a provider of a product so as to allow appropriate posted information to be disclosed. However, when posted information is posed on a plurality of posting websites, there is a problem that manually monitoring the posted information takes labor and time.

In view of the above, an object of the present invention is to provide an information processing system capable of solving the problem described above, that is, a problem that manually monitoring the posted information posted on a plurality of posting websites takes labor and time.

### Solution to Problem

An information processing system, according to one aspect of the present invention, is configured to include

an acquisition means for acquiring posted information corresponding to a specific object from each of a plurality of posting websites on which the posted information, posted by a user who used the specific object, is disclosed on the Internet, and

an output means for outputting the posted information corresponding to the specific object acquired from each of the plurality of posting websites so as to display the posted information in a list.

An information processing method, according to one aspect of the present invention, is configured to include

acquiring posted information corresponding to a specific object from each of a plurality of posting websites on which the posted information, posted by a user who used the specific object, is disclosed on the Internet, and

outputting the posted information corresponding to the specific object acquired from each of the plurality of posting websites so as to display the posted information in a list.

A program, according to one aspect of the present invention, is configured to cause an information processing device to realize

an acquisition means for acquiring posted information corresponding to a specific object from each of a plurality of posting websites on which the posted information, posted by a user who used the specific object, is disclosed on the Internet, and

an output means for outputting the posted information corresponding to the specific object acquired from each of the plurality of posting websites so as to display the posted information in a list.

### Advantageous Effects of Invention

With the configurations described above, the present invention is able to reduce the labor and time for manually monitoring the posted information posted on a plurality of posting websites.

### BRIEF DESCRIPTION OF DRAWINGS

FIG. 1 illustrates the overall configuration of an information processing system according to a first exemplary embodiment of the present invention.

FIG. 2 is a function block diagram illustrating a configuration of a management server disclosed in FIG. 1.

FIG. 3 illustrates a state of processing by the management server disclosed in FIG. 2.

FIG. 4 illustrates a state of processing by the management server disclosed in FIG. 2.

FIG. 5 illustrates a state of processing by the management server disclosed in FIG. 2.

FIG. 6 is a flowchart illustrating an operation of the management device disclosed in FIG. 2.

### DESCRIPTION OF EMBODIMENTS

### First Exemplary Embodiment

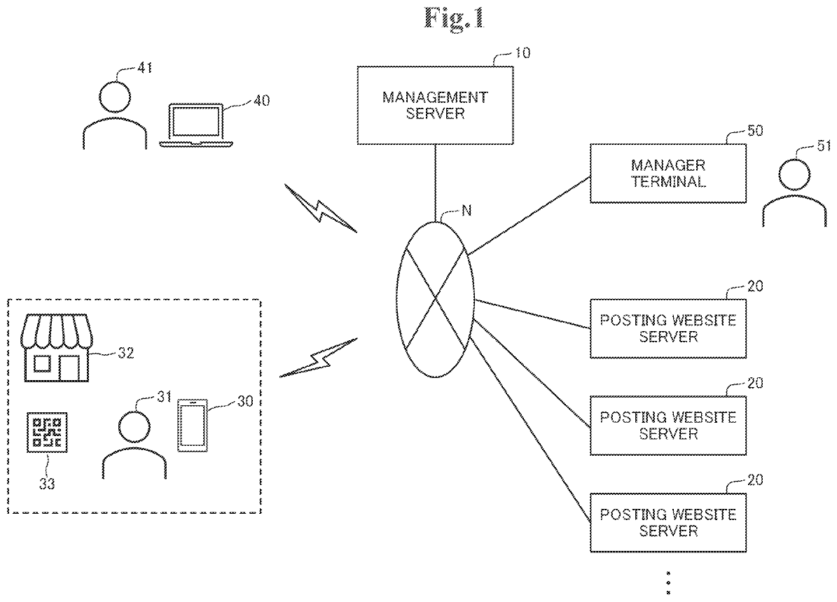

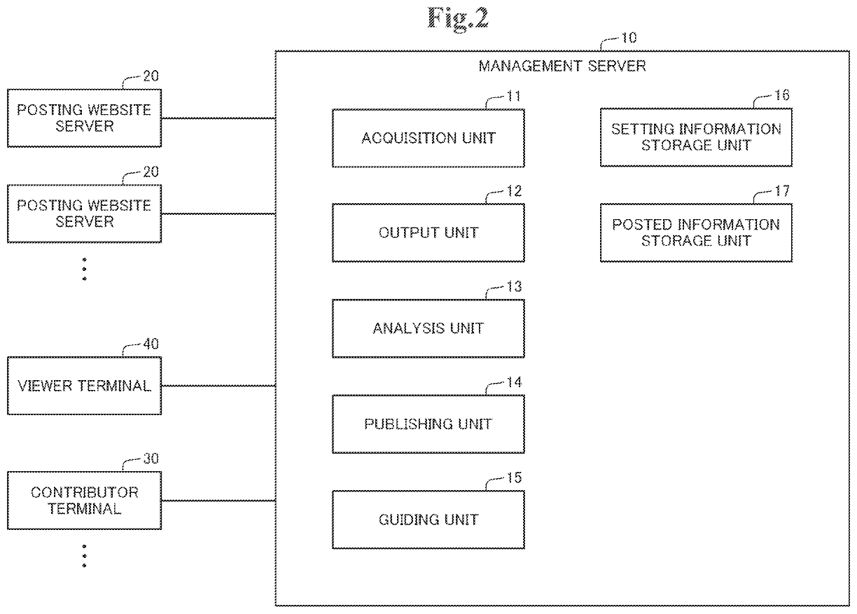

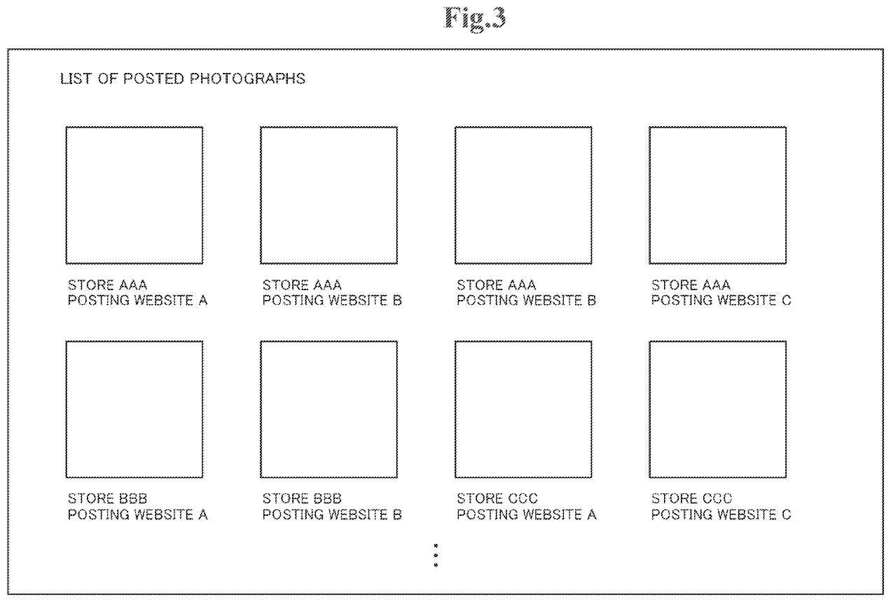

A first exemplary embodiment of the present invention will be described with reference to FIGS. 1 to 6. FIGS. 1 and 2 are diagrams for explaining a configuration of an information processing system, and FIGS. 3 to 6 are illustrations for explaining processing operation of the information processing system.

### [Configuration]

An information processing system of the present invention is a system mainly used for managing posted information posted on posting websites, that is, so-called review websites. As illustrated in FIG. 1, the information processing system is configured of a management server 10, a plurality of posting website servers 20, a contributor terminal 30, a viewer terminal 40, and a manager terminal 50, connected over a network N. Hereinafter, the respective constituent elements will be described in detail.

The posting website server 20 is an information processing device that is managed by a business operator who provides a service of disclosing posted information, and has opened a website such as a posting website on the Internet. In the present embodiment, it is assumed that a posting website provided by each posting website server 20 discloses, for example, a page on which information of a store 32 such as a restaurant is posted and also a page on which posted information from the contributor 31 who is a user having used the store 32 is posted. It is also assumed that the posted information that is posted by the contributor 31 and disclosed includes, for example, photographs (captured images) of the interior and the food of the store 32 (object), text information about impressions of the service and the food provided at the store 32, and numerical evaluation information representing the evaluation of the store 32.

In the present embodiment, there are a plurality of posting website servers 20 and they have opened different posting websites respectively. Therefore, it is assumed that posted information regarding the same store 32 is posted and disclosed in the respective posting websites opened by the respective posting website servers 20.

Note that posted information handled by a posting website provided by each posting website server 20 is not limited to information about the store 32 such as a restaurant. It may be posted information about a product or a service (object). Moreover, posted information is not limited to information about stores or products, but may be information about any object. Furthermore, the posting website server 20 does not necessarily disclose posted information by distinguishing information for each object such as each store or each product, and may disclose posted information without distinguishing the objects. For example, the posting website server may disclose posted information by distinguishing it for each contributor 31.

The contributor terminal 30 (user terminal) is an information processing terminal such as a smartphone, a laptop computer, or the like operated by the contributor 31 who is a user having used an object such as the store 32. The contributor terminal 30 has a function of, when being operated by the contributor 31, accessing a posting website on the Internet and posting information to such a posting website. For example, the contributor terminal 30 posts photographs of the interior of the store 32 and photographs of the food served in the store 32, captured by the contributor 31, as posted information, and posts evaluation information in which the store 32 is evaluated by a numerical value in multiple stages and text information representing the impressions in text, input by the contributor 31, as posted information.

Note that the contributor terminal 30 may directly access the posting website, or may access the posting website by being guided from an access destination based on address information such as a QR code 33 installed in the store 32. Moreover, in the case where the access destination of the address information such as the QR code 33 installed in the store 32 is a questionnaire website of the store 32, the contributor terminal 30 also has a function of transmitting an answer to the questionnaire presented on the questionnaire website.

The viewer terminal 40 is an information processing terminal such as a smartphone or a laptop computer operated by the viewer 41. The viewer terminal 40 has a function of, when being operated by the viewer 41, accessing a posting website on the Internet and viewing posted information disclosed on the posting website. For example, the viewer terminal 40 can view photographs of the interior of the store 32 and photographs of the food served in the store 32, evaluation information in which the store 32 is evaluated by a numerical value in multiple stages, and text information representing the impression in text, posted by the contributor 31.

The manager terminal 50 is an information processing terminal operated by a manager 51 who manages posted information of the store, in the business operator operating the store. The manager terminal 50 accesses the management server 10, and manages the posted information about the store by displaying and monitoring the posted information of the store acquired by the management server 10 and analyzing the posted information, as described later. The manager terminal 50 also manages information such as questionnaires about the store acquired by the management server 10. Moreover, the manager terminal 50 may publish information about the store on each posting website via the management server 10. Note that the number of stores in which the manager 51 manages posted information is not limited to one, and may be plural.

The management server 10 is configured of one or a plurality of information processing devices each having an arithmetic unit and a storage device. As illustrated in FIG. 2, the management server 10 includes an acquisition unit 11, an output unit 12, an analysis unit 13, a publishing unit 14, and a guiding unit 15. The functions of the acquisition unit 11, the output unit 12, the analysis unit 13, the publishing unit 14, and the guiding unit 15 can be realized through execution, by the arithmetic unit, of a program for implementing the respective functions stored in the storage device. The management server 10 also includes a setting information storage unit 16 and a posted information storage unit 17. Each of the setting information storage unit 16 and the posted information storage unit 17 is configured of a storage device. Hereinafter, the respective constituent elements will be described in detail.

The acquisition unit 11 (acquisition means) accesses each posting website server 20, acquires posted information disclosed on each posting website, and stores it in the posted information storage unit 17. At that time, the acquisition unit 11 acquires the pieces of posted information of stores while distinguishing the pieces of information by the stores from each posting website server 20, and stores them in the posted information storage unit 17. For example, access information to each posting website server 20 is stored for each store 32 in the setting information storage unit 16 in advance, and on the basis of such access information, the acquisition unit 11 accesses posted information of the specific store on each posting website server 20 and acquires the posted information. In this way, the acquisition unit 11 acquires pieces of posted information corresponding to a specific store posted on respective posting websites.

In the setting information storage unit 16, for example, there is a case where a plurality of stores operated by the same business operator or operated by business operators forming a group are associated with each other and registered as a store group. In that case, the acquisition unit 11 acquires, from each posting website server 20, posted information corresponding to each of the specific stores forming a store group, and stores the acquired posted information while classifying the acquired pieces of posted information into respective store groups, in the posted information storage unit 17.

However, the function of acquiring posted information from respective posting websites by the acquisition unit 11 may be implemented by another information processing device on the network N, that is, a so-called crawler. In that case, the acquisition unit 11 acquires the posted information from the crawler, and stores the pieces of posted information while classifying them into respective stores or store groups as described above.

The output unit 12 outputs the posted information about a specific store, acquired from the posting website servers 20, to display it on the manager terminal 50. At that time, when there are a plurality of pieces of posted information about a specific store acquired from the posting website servers 20 respectively, the output unit 12 outputs the pieces of posted information to display them in a list. Moreover, in the case where a plurality of specific stores are associated with each other and form a store group as described above, the output unit 12 outputs the pieces of posted information about the specific stores so as to display them collectively in a list. Note that the output unit 12 displays the posted information in associated with information such as the store name specifying the store of the posted information, and information such as the posting website name specifying the posting website.

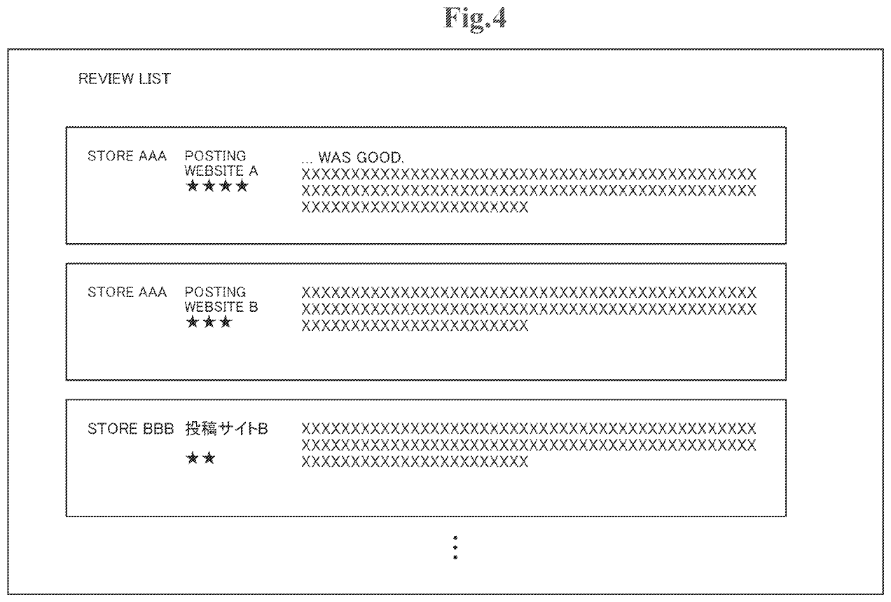

For example, as illustrated in FIG. 3, the output unit 12 outputs the posted information so as to display a list containing only photographs of the posted information on the manager terminal 50. The example of FIG. 3 is a case where “AAA store”, “BBB store”, and “CCC store” are associated with each other as a store group. For each of the stores, the output unit 12 outputs photographs as posted information that are posted on a plurality of posting websites such as “posting website A”, “posting website B”, and “posting website C”, in a list. Further, as illustrated in FIG. 4, the output unit 12 outputs the posted information so as to display a list containing evaluation information and text information of the posted information on the manager terminal 50. The example of FIG. 4 is a case where “AAA store”, “BBB store”, and “CCC store” are associated with each other as a store group. For each of the stores, the output unit 12 outputs evaluation information and text information as posted information that are posted on a plurality of posting websites such as “posting website A”, “posting website B”, and “posting website C”, in a list. In FIG. 4, “star marks” are evaluation information, and the number thereof numerically represents the evaluation value, indicating that the evaluation is higher as the number is larger. Moreover, in FIG. 4, “ . . . is good” and “xxxxxxx” are text information such as impressions of the store.

The output unit 12 may output the posted information to the manager terminal 50 in any to display it in any display format. For example, the output unit 12 may display posted information including all of the photographs, evaluation information, and text information in a list, or display posted information including one or a combination of two of the photographs, evaluation information, and text information in a list. Further, the output unit 12 may output a list for each store in which posted information about each store is displayed.

The output unit 12 may have a function of changing the disclosure state on the posting website where the posted information is disclosed, according to the operation from the manager terminal 50 on the displayed posted information. For example, when an operation is performed on the manager terminal 50 to delete photographs or text information in the posted information, the output unit 12 may perform control to delete the photographs or the text information from the corresponding posting website to stop the disclosure.

The analysis unit 13 (analysis means) performs every analysis process related to the acquired posted information. For example, the analysis unit 13 aggregates the number of pieces of posted information for each store or each posting website, and aggregates the number of pieces of posted information for each business operator who operates and manages the store or each manager. It is assumed that the business operator and the manager of the store are stored in the setting information storage unit 16 in advance. Further, the analysis unit 13 performs an analysis process of extracting a keyword included in the text information in the posted information and calculating the appearance frequency thereof for each store, or performs analysis process of calculating the evaluation value indicated by the evaluation information included in the posted information for each store. Then, the result of posted information analysis process performed by the analysis unit 13 is output by the output unit 12 so as to be displayed on the manager terminal 50. Note that the posted information analysis process by the analysis unit 13 is not limited to that described above, and any analysis process may be performed.

The publishing unit 14 (publishing means) has a function of performing control to publish new publication information about a store on each of the information disclosure pages of the posting websites corresponding to the store managed by the manager 51 of the manager terminal 50, in response to an instruction from the manager terminal 50. For example, the publishing unit 14 transmits a generation screen for publication information to display it on the manager terminal 50, and performs control to publish the publication information, input to the generation screen, on the information disclosure pages of the posting websites corresponding to the store in a batch. Note that the publication information related to the store includes, for example, information of the business hours of the store, information of a campaign to be held at the store, information of products provided at the store, and the like, but the publication information may be any information.

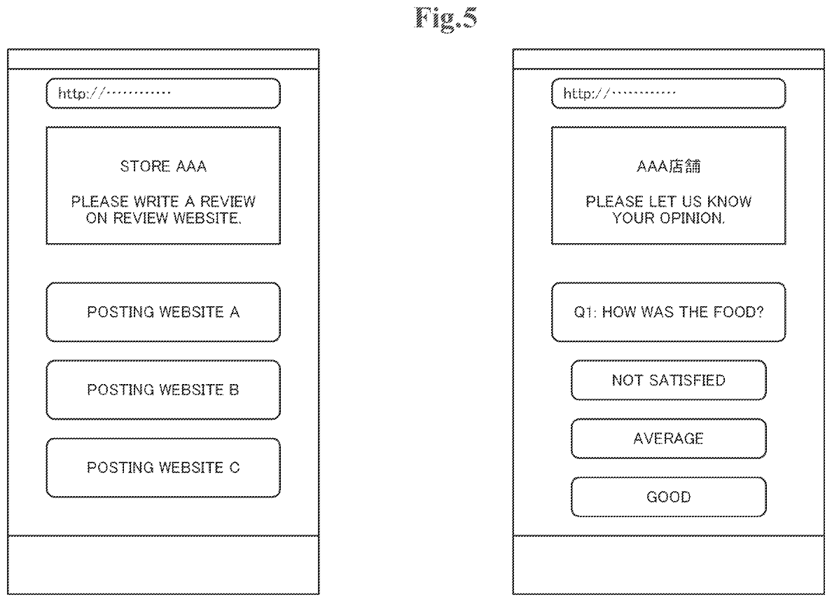

The guiding unit 15 (guiding means) transmits guide information related to the store 32, having been prepared in advance, to display it on to the contributor terminal 30 that made an access on the basis of address information such as a QR code 33 set in the store 32 as illustrated in FIG. 1. The guide information is stored in the setting information storage unit 16 in advance, and is website information including link information to a plurality of posting websites on which posted information about the store 32 can be posted, as illustrated in the left drawing of FIG. 5 for example. In that case, when the contributor 31 selects link information of any of the posting websites on the contributor terminal 30, the contributor terminal 30 is connected to the selected posting website, and posted information can be posted. The guide information may also be website information in which an answer can be made to a questionnaire about the store 32, as illustrated in the right drawing of FIG. 5 for example. In that case, when the contributor 31 answers the questionnaire on the contributor terminal 30, the answer to the questionnaire is stored in the management server 10, and the questionnaire result is analyzed by the analysis unit 13, and it is output by the output unit 12 so as to be displayed on the manager terminal 50.

Note that the QR code 33 to be set at the store 32 is installed in such a manner that a sticker on which the QR code corresponding to the address information to the guide information is printed is stuck in the store, so that it is readable by using a camera function of the contributor terminal 30. The address information to the guide information is not limited to be shown as a QR code. An installed object including a contactless IC chip in which address information is stored and that can transmit the address information may be set in the store, which may be read by a short-range radio device of the contributor terminal 30.

### [Operation]

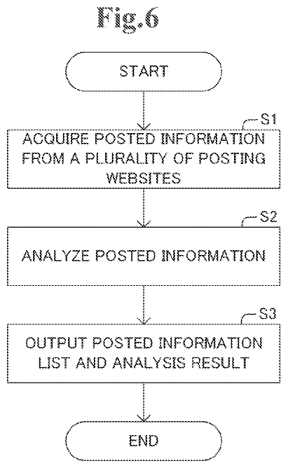

Next, operation of the information processing system described above, in particular, operation of the management server 10, will be described with mainly reference to the flowchart of FIG. 6.

First, on a plurality of posting website servers 20, posted information about the store 32 is posted on each posting website by the contributor 31 and disclosed, which is viewable from the viewer terminal 40 of the viewer 41.

The management server 10 acquires posted information disclosed on the respective posting websites from a plurality of posting website servers 20 periodically or at any timing (step S1). Then, the management server 10 stores the posted information acquired from the posting website servers 20, for each store or for each store group.

Then, the management server 10 analyzes the posted information in response to an instruction from the manager terminal 50 (step S2). For example, the management server 10 aggregates the number of pieces of posted information for each store or each posting website, aggregates the evaluation values of the store, and performs an analysis process such as extraction of a keyword included in the posted information.

Then, the management server 10 outputs the posted information and the analysis process result so as to display them on the manager terminal 50, in response to an instruction from the manager terminal 50 (step S3). For example, the management server 10 outputs, to the manager terminal 50, photographs in the posted information about the associated store group to display them in a list as illustrated in FIG. 3, or outputs evaluation information and text information included in the posted information so as to display them in a list as illustrated in FIG. 4.

As described above, in the present invention, posted information about a store or a plurality of stores constituting a group, posted on a plurality of posting websites, is displayed in a list. Accordingly, the manager who manages the posted information of the store can easily monitor the content of the posted information posted on a plurality of posting websites, and can take actions such as deleting inappropriate posted information. As a result, in the present invention, it is possible to reduce the labor and time for manually monitoring the posted information posted on a plurality of posting websites.

When an access is made from the contributor terminal 30 on the basis of address information such as the QR code 33 set in the store 32, the management server 10 may provide website information including link information to a plurality of posting websites on which posted information about the store 32 can be posted as described in the left drawing of FIG. 5, or provide website information on which an answer to a questionnaire about the store 32 can be made as illustrated in the right drawing of FIG. 5. As a result, it is possible to urge the contributor 31 to post posted information or urge the contributor 31 to answer the questionnaire.

Moreover, when the management server 10 receives an instruction to publish publication information on a posting website from the manager terminal 50, the management server 10 can publish the publication information in a batch on the respective information disclosure pages of a plurality of posting websites corresponding to the store managed by the manager 51. As a result, management of the posting websites by the manager 51 can be made easily.

While the present invention has been described with reference to the exemplary embodiments described above, the present invention is not limited to the above-described embodiments. The form and details of the present invention can be changed within the scope of the present invention in various manners that can be understood by those skilled in the art. Further, at least one of the functions of the acquisition unit 11, the output unit 12, the analysis unit 13, the publishing unit 14, the guiding unit 15, the setting information storage unit 16, and the posted information storage unit 17 described above may be carried out by an information processing device provided and connected to any location on the network, that is, may be carried out by so-called cloud computing.

Note that the program described above can be supplied to a computer by being stored in a non-transitory computer-readable medium of any type. Non-transitory computer-readable media include tangible storage media of various types. Examples of non-transitory computer-readable media include magnetic storage media (for example, flexible disk, magnetic tape, and hard disk drive), magneto-optical storage media (for example, magneto-optical disk), a CD-ROM (Read Only Memory), a CD-R, a CD-R/W, and semiconductor memories (for example, mask ROM, PROM (Programmable ROM), EPROM (Erasable PROM), a flash ROM, and a RAM (Random Access Memory)). The program may be supplied to a computer by a transitory computer-readable medium of any type. Examples of transitory computer-readable media include electric signals, optical signals, and electromagnetic waves. A transitory computer-readable medium can be supplied to a computer via a wired communication channel such as a wire and an optical fiber, or a wireless communication channel.

### <Supplementary Notes>

The whole or part of the exemplary embodiments disclosed above can be described as the following supplementary notes. Hereinafter, outlines of the configurations of an information processing system, an information processing method, and a program, according to the present invention, will be described. However, the present invention is not limited to the configurations described below.

### (Supplementary Note 1)

An information processing system comprising:

acquisition means for acquiring posted information corresponding to a specific object from each of a plurality of posting websites on which the posted information, posted by a user who used the specific object, is disclosed on Internet; and

output means for outputting the posted information corresponding to the specific object acquired from each of the plurality of posting websites so as to display the posted information in a list.

### (Supplementary Note 2)

The information processing system according to supplementary note 1, wherein

the acquisition means acquires the posted information corresponding to each of a plurality of the specific objects having been associated with each other, from each of the plurality of posting websites, and

the output means outputs the posted information corresponding to the plurality of the specific objects acquired from each of the plurality of posting websites so as to display the posted information in a list.

### (Supplementary Note 3)

The information processing system according to supplementary note 1 or 2, wherein

when displaying the posted information in a list, the output means displays the posted information in association with information specifying the specific object corresponding to the posted information and information specifying the posting website from which the posted information is acquired.

### (Supplementary Note 4)

The information processing system according to any of supplementary notes 1 to 3, wherein

the acquisition means acquires a captured image related to the specific object that is the posted information, and

the output means outputs the acquired captured image so as to display the captured image in a list.

### (Supplementary Note 5)

The information processing system according to any of supplementary notes 1 to 4, wherein

the acquisition means acquires text information related to the specific object that is the posted information, and

the output means outputs the acquired text information so as to display the text information in a list.

### (Supplementary Note 6)

The information processing system according to any of supplementary notes 1 to 5, further comprising

analysis means for performing an analysis process, set in advance, on the acquired posted information, wherein

the output means outputs information based on the analysis process so as to display the information.

### (Supplementary Note 7)

The information processing system according to any of supplementary notes 1 to 6, further comprising

publishing means for performing control to publish new publication information related to the specific object in a batch on an information disclosure page corresponding to the specific object prepared in each of the plurality of posting websites.

### (Supplementary Note 8)

The information processing system according to any of supplementary notes 1 to 7, further comprising

guiding means for transmitting, to a user terminal that makes an access on a basis of address information readable from an installed object installed in the specific object, guide information including link information for accessing each of the plurality of posting websites corresponding to the specific object.

### (Supplementary Note 9)

An information processing method comprising:

acquiring posted information corresponding to a specific object from each of a plurality of posting websites on which the posted information, posted by a user who used the specific object, is disclosed on Internet; and outputting the posted information corresponding to the specific object acquired from each of the plurality of posting websites so as to display the posted information in a list.

### (Supplementary Note 10)

A program for causing an information processing device to realize:

acquisition means for acquiring posted information corresponding to a specific object from each of a plurality of posting websites on which the posted information, posted by a user who used the specific object, is disclosed on Internet; and

output means for outputting the posted information corresponding to the specific object acquired from each of the plurality of posting websites so as to display the posted information in a list.

### REFERENCE SIGNS LIST

10 management server
11 acquisition unit
12 output unit
13 analysis unit
14 publishing unit
15 guiding unit
16 setting information storage unit
17 posted information storage unit
20 posting website server
30 contributor terminal
31 contributor
32 store
33 QR code
40 viewer terminal
41 viewer
50 manager terminal
51 manager

1. An information processing device comprising:
at least one memory configured to store instructions; and
at least one processor configured to execute instructions to
acquire posted information corresponding to a specific store from each of a plurality of posting websites on which the posted information, posted by a user who used the specific store, is disclosed on Internet;
output the posted information corresponding to the specific store acquired from each of the plurality of posting websites so as to display the posted information in a list; and
perform control to publish new publication information related to the specific store in a batch on an information disclosure page corresponding to the specific store prepared in each of the plurality of posting websites.

2. The information processing device according to claim 1, wherein the at least one processor is configured to execute the instructions to:
acquire the posted information corresponding to each of a plurality of the specific stores, the specific stores constituting a store group operated by a same business operator and having been associated with each other, from each of the plurality of posting websites, and
output the posted information corresponding to the plurality of the specific stores constituting the store group acquired from each of the plurality of posting websites so as to display the posted information in a list.

3. The information processing device according to claim 1, wherein the at least one processor is configured to execute the instructions to:
when displaying the posted information corresponding to each of the plurality of the specific stores constituting the store group in a list, display the posted information in association with information specifying the specific store corresponding to the posted information and information specifying the posting website from which the posted information is acquired.

4-7. (canceled)

8. The information processing device according to claim 1, wherein the at least one processor is configured to execute the instructions to:
transmit, to a user terminal that makes an access on a basis of address information readable from an installed object installed in the specific store, guide information including link information for accessing each of the plurality of posting websites corresponding to the specific store.

9. An information processing method comprising:
acquiring posted information corresponding to a specific store from each of a plurality of posting websites on which the posted information, posted by a user who used the specific store, is disclosed on Internet;
outputting the posted information corresponding to the specific store acquired from each of the plurality of posting websites so as to display the posted information in a list; and
performing control to publish new publication information related to the specific store in a batch on an information disclosure page corresponding to the specific store prepared in each of the plurality of posting websites.

10. A non-transitory computer readable medium storing thereon a program comprising instructions for causing an information processing device to execute processing to:
acquire posted information corresponding to a specific store from each of a plurality of posting websites on which the posted information, posted by a user who used the specific store, is disclosed on Internet;
output the posted information corresponding to the specific store acquired from each of the plurality of posting websites so as to display the posted information in a list; and
perform control to publish new publication information related to the specific store in a batch on an information disclosure page corresponding to the specific store prepared in each of the plurality of posting websites.

11. The information processing device according to claim 8, wherein the at least one processor is configured to execute the instructions to
transmit the guide information including the link information for accessing each of the plurality of posting websites from which the posted information corresponding to the specific store is available.

12. The information processing device according to claim 11, wherein the at least one processor is configured to execute the instructions to
transmit the guide information in such a manner that the link information of any of the plurality of posting websites, from which the posted information corresponding to the specific store is available, is selectable.

13. The information processing device according to claim 2, wherein the at least one processor is configured to execute the instructions to
aggregate a number of acquired pieces of the posted information for each of the specific stores constituting the store group.

14. The information processing device according to claim 1, wherein the at least one processor is configured to execute the instructions to
aggregate a number of acquired pieces of the posted information for each of the plurality of posting websites.
